(19) United States
(12) Patent Application Publication
(10) Pub. No.: US 2026/0266767 A1
(43) Pub. Date: Sep. 10, 2026

(54) METHOD AND DEVICE FOR SURFACE DEFECT MONITORING USING ULTRASONIC BULK WAVE

(71) Applicant: Agency for Science, Technology and Research, Singapore (SG)

(72) Inventors: Xiaotian Li, Singapore (SG); Kui Yao, Singapore (SG); Voon Kean Wong, Singapore (SG); Yasmin MOHAMED YOUSRY, Singapore (SG); Boon Kiang, David LIM, Singapore (SG)

(21) Appl. No.: 19/164,129

(22) PCT Filed: Mar. 4, 2024
(86) PCT No.: PCT/SG2024/050131

§ 371 Date: Sep. 10, 2025

(30) Foreign Application Priority Data
Mar. 13, 2023 (SG) 10202300670W

(51) Int. Cl. G01N 29/04; G01N 29/44

(52) U.S. Cl. CPC G01N 29/043; G01N 29/4445; G01N 2291/0289

(57) ABSTRACT

A device and method of monitoring a surface defect on a proximal wall of a structure includes transmitting a generated ultrasonic bulk wave from an ultrasonic transducer array disposed on the proximal wall, the generated ultrasonic bulk wave being transmitted from the proximal wall as a spread wave having a central line angularly displaced relative to the proximal wall. The method includes determining at least one characteristic of the surface defect based on a reflected ultrasonic bulk wave sensed by the ultrasonic transducer array, the ultrasonic transducer array being disposed on the proximal wall and disposed to one side of the surface defect. The method may include determining at least one characteristic of the surface defect based on respective arrival times of the reflected ultrasonic bulk wave sensed by at least two ultrasonic transducers selected from the ultrasonic transducer array.

### RELATED APPLICATION

This application claims the benefit of priority to the Singapore Application No. 10202300670W filed Mar. 13, 2023, the contents of which are hereby incorporated by reference in their entirety for all purposes.

### TECHNICAL FIELD

The present application relates to surface defect monitoring and, in particular, to a method of surface defect monitoring using ultrasonic waves.

### BACKGROUND

Surface cracks exist as very common defects in various structures. Monitoring of the initiation and propagation of surface cracks is important for safety.

Ultrasonic testing is one method used in defect monitoring. For surface defects, ultrasonic testing based on Rayleigh waves is generally preferred. As a surface ultrasonic wave, the energy of the Rayleigh wave is concentrated near the surface of the structure, making it more sensitive to surface defects than other wave modes.

For the purpose of detecting surface defects, the Rayleigh wave transducer is mounted on a wedge so as to direct the ultrasonic wave towards the surface region of the structure. In some cases, phased arrays can be used to replace the wedge. For example, the plurality of transducers may be fired one after another in sequential order with a predetermined time delay between successive waves such that, collectively, an angled wave is propagated towards the surface region of the structure. Nevertheless, phased arrays are less powerful than other conventional transducers. Hence, a phased array is typically used only for sensing within a short distance or a highly localized region near the phased array itself.

### SUMMARY

In one aspect, a method of monitoring a surface defect on a proximal wall of a structure includes transmitting a generated ultrasonic bulk wave from an ultrasonic transducer array disposed on the proximal wall, the generated ultrasonic bulk wave being transmitted from the proximal wall as a spread wave having a central line angularly displaced relative to the proximal wall. The method includes determining at least one characteristic of the surface defect based on reflected ultrasonic bulk wave sensed by the ultrasonic transducer array, the ultrasonic transducer array being disposed on the proximal wall and disposed to one side of the surface defect.

The method may include determining at least one characteristic of the surface defect based on respective arrival times of the reflected ultrasonic bulk wave sensed by at least two ultrasonic transducers selected from the ultrasonic transducer array.

In another aspect, a device for monitoring a surface defect on a proximal wall of a structure includes an ultrasonic transducer array and a processor. The ultrasonic transducer array includes a plurality of ultrasonic transducers spaced apart from one another, the ultrasonic transducer array being disposed on the proximal wall and oriented to transmit a generated ultrasonic bulk wave spread from the proximal wall with the central line of the spread wave in a direction normal or substantially normal to the proximal wall. The processor is operably coupled to the ultrasonic transducer array, the processor being configured to determine at least one characteristic of the surface defect based on a twice reflected ultrasonic bulk wave sensed by at least two selected from the plurality of ultrasonic transducers, in which the ultrasonic transducer array is longitudinally spaced apart from the surface defect.

The reflected ultrasonic bulk wave may include a twice reflected ultrasonic bulk wave.

### BRIEF DESCRIPTION OF THE DRAWINGS

Various embodiments will be described with reference to the following figures:

FIG. 1 is a schematic diagram illustrating a method for surface defect monitoring according to embodiments of the present disclosure;

FIG. 2 is a schematic diagram of a beam spreading for a single ultrasonic transducer;

FIG. 3A is a schematic diagram illustrating the method to simultaneously locate a surface defect and determine a depth of the surface defect;

FIG. 3B is a schematic diagram illustrating an alternative embodiment of the method to simultaneously locate a surface defect and determine a depth of the surface defect;

FIG. 4 is a signal intensity plot showing generated and reflected ultrasonic waves according to embodiments of the present disclosure;

FIG. 5 is a schematic diagram illustrating an example of a two-dimensional ultrasonic transducer array;

FIG. 6A and FIG. 6B are perspective views of the ultrasonic transducer array of FIG. 5 showing different sets of ultrasonic transducers in use;

FIG. 7A and FIG. 7B are plots showing the ultrasonic wave signals from different sets of ultrasonic transducers in the array of FIG. 5;

FIG. 8 shows the ultrasonic wave signals detected with yet another of the transducer in the ultrasonic transducer array of FIG. 5 operating as the transmitter;

FIG. 9 shows an example of an ultrasonic transducer array disposed on a tubular structure;

FIG. 10 is a schematic diagram of the method according to embodiments of the present disclosure; and

FIG. 11 shows a conventional method of detecting a surface crack.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise.

Terms such as “first” and “second” are used in the description and claims only for the sake of brevity and clarity, and do not necessarily imply a priority or order, unless required by the context. The terms “about” and “approximately” as applied to a stated numeric value encompasses the exact value and a reasonable variance as will be understood by one of ordinary skill in the art, and the terms “generally” and “substantially” are to be understood in a comparable manner, unless otherwise specified.

Some methods may be described in terms of steps merely to aid understanding and/or for convenient reference. The delineation between one step and another step may be merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

In the present disclosure, unless otherwise dictated by the context, the term “surface defect” refers to a discontinuity in the material of a structure, in which the discontinuity extends from or is present on a surface of the structure. In some cases, the discontinuity includes a crack at the surface of the structure. In some cases, the discontinuity includes a crack that has propagated from the surface of the structure into the body of the structure. In some cases, the discontinuity includes an inclusion or non-uniformity in the material of the structure, in which the inclusion or non-uniformity is located relatively near the surface of the structure. As used herein, “defects” include but are not limited to cracks, inclusions, and/or discontinuities or non-uniformities in the material of the structure that may have a negative effect on the use or function of the structure. The present method and system are useful for monitoring surface defects, regardless of the cause of the surface defects. Some surface defects may be fatigue cracks commonly found in metal structures. Some surface defects result from fatigue damage and initiate as shear cracks on crystallographic slip planes. Some surface defects may be the result of corrosion. Some surface defects may include but are not limited to defects that appear in welded structures or near welded joints. A surface defect may be characterized by irregular defect dimensions. Taking reference from the surface where the surface defect can be found, the surface defect may be described by a defect depth or a depth of the surface defect. For example, the surface defect may extend from the surface of the structure into the material of the structure for a distance (depth). In various examples, the surface defect may initiate at a surface of a structure and subsequently propagate, develop, or grow. This may include an increase in the depth, e.g., the surface defect extends longer or further into the material of the structure.

The term “structure” as used herein refers generally to any physical article to which the present method and system may be applied, including but not limited to one or more parts of buildings, bridges, tunnels, transportation equipment, pipes, etc.

As used herein, the terms “surface” and “wall” may be used interchangeably in referring to a superficial area or two-dimensional boundary at least partially defining a shape of the structure. A surface may be an external facing area or an area defining an inner space or a closed cavity, etc.

As used herein, the term “ultrasonic transducer” refers to a device operable to convert electrical signals into ultrasonic waves or operable to convert ultrasonic waves into electrical signals. An ultrasonic transducer may be referred to as a “transmitter” when configured or operated to generate an ultrasonic wave in response to an electrical signal input. An ultrasonic transducer may be referred to as a “receiver” when the ultrasonic transducer is configured or operated to generate an electrical signal output in response to detecting an ultrasonic wave.

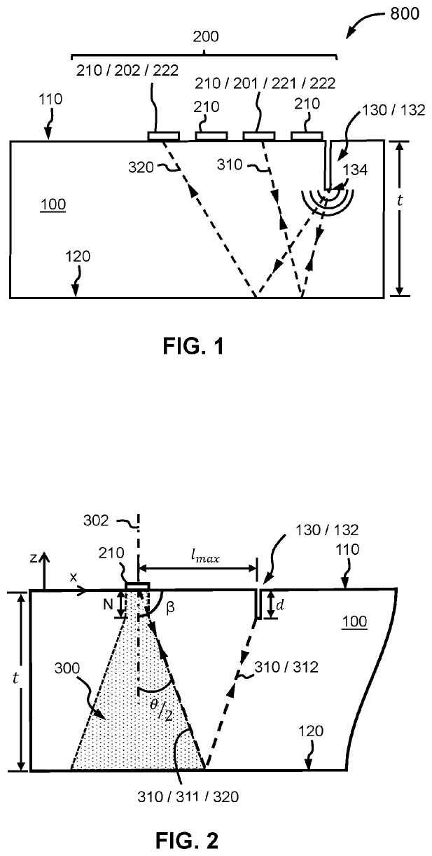

FIG. 1 is a schematic diagram illustrating a system 800 and a method 900 of surface defect monitoring using an ultrasonic transducer array 200 to generate at least one ultrasonic bulk wave 300. The ultrasonic transducer array 200 includes at least two ultrasonic transducers 210 disposed on the same surface 110 to be monitored for the presence and/or growth of surface defects 130.

The system 800 includes a first ultrasonic transducer 210/201 and a second ultrasonic transducer 210/202 disposed on a proximal wall 110 of a structure 100, to monitor a surface defect 130 at the proximal wall 110. The first ultrasonic transducer 210/201 is configured to generate or transmit an ultrasonic bulk wave 310 toward a distal surface 120 of the structure 100. The second ultrasonic transducer 210/202 is configured to detect a twice reflected ultrasonic bulk wave 320, in which the twice reflected ultrasonic bulk wave 320 is detected by the second ultrasonic transducer 210/202 after the ultrasonic bulk wave has undergone reflection twice at the distal surface 120.

In another aspect, the method 900 includes using the first ultrasonic transducer 210/201 to direct an ultrasonic bulk wave 310 into the structure 100 and using the second ultrasonic transducer 210/202 to detect a twice reflected ultrasonic bulk wave 320, in which the first ultrasonic transducer 210/201 and the second ultrasonic transducer 210/202 are disposed on the surface of interest 110. For the sake of brevity, as used herein, the term “surface of interest” refers to the surface to be inspected or monitored for surface defect formation and/or propagation.

In another aspect, the method 900 includes disposing the first ultrasonic transducer 210/201 and the second ultrasonic transducer 210/202 on the surface of interest 110, with both the first ultrasonic transducer 210/202 and the second ultrasonic transducer 210/202 being positioned or located on surface of interest 110 on the same side of a region 132 of interest to be monitored. For the sake of brevity, as used herein, the term “region of interest” refers to a region in which the defect to be monitored is known to be present or a region to be monitored for possible surface defect formation and/or propagation.

Embodiments of the method 900 include generating and detecting ultrasonic bulk waves 310 using an ultrasonic transducer array 200 on the same side of a surface defect 130, in which the ultrasonic transducer array 200 includes at least two ultrasonic transducers 210. The ultrasonic transducers 210 may be bonded or in-situ fabricated on the same surface of the structure 100 as the surface defect.

The ultrasonic transducers 210 may be fabricated based on a piezoelectric material. Various embodiments of the ultrasonic transducers 210 are in-situ fabricated on the structure 100, e.g., the ultrasonic transducers 210 are integrated into proximal wall 110 of the structure 100 by any one or more methods such as but not limited to spray coating, spin coating, thermal spray, and tape casting of one or more piezoelectric materials on the structure 100 after or along with formation of the structure 100.

The method 900 includes generating an ultrasonic bulk wave 310 using an ultrasonic transducer array 200 disposed at a proximal wall 110 of the structure 100 (which is also the surface of interest) and configuring the generated ultrasonic bulk wave 310 (the transmitted ultrasonic bulk wave), such that the ultrasonic bulk wave 310 reaches a back wall 120 (distal surface) of the structure 100. At least a part of the ultrasonic bulk wave 310 is reflected off the back wall 120 and reaches a surface defect tip 134 (e.g., where the surface defect or discontinuity ends). The ultrasonic bulk wave 310 is diffracted at the surface defect tip 134 and again travels through the material of the structure 100 to reach the back wall 120 of the structure 100. The ultrasonic bulk wave is once again reflected by the same back wall 120 of the structure 100. The now twice reflected ultrasonic bulk wave 320 travels back towards the proximal wall 110 where it is detected by the ultrasonic transducers 210 in the ultrasonic transducer array 200.

The method 900 further includes determining the location and/or depth of the surface defect by analyzing the arrival time of the twice reflected ultrasonic bulk wave 320. For example, the depth of the surface defect may be determined based on the respective arrival times of the twice reflected ultrasonic bulk wave 320. For example, the location of the surface defect may be determined by using different ultrasonic transducers 210 in the ultrasonic transducer array 200 as the ultrasonic bulk wave transmitter 221 and/or ultrasonic bulk wave receiver 222.

The method 900 may further include selecting different ones of the ultrasonic transducers 210 from an array of ultrasonic transducers (ultrasonic transducer array 200) to provide at least two output signals, each corresponding to a respective detection of a twice reflected ultrasonic bulk wave 320 transmitted from the same ultrasonic transducer array 200, and using the two output signals to determine a location of a surface defect relative to the ultrasonic transducer array 200.

In some examples, the ultrasonic transducers 210 in the ultrasonic transducer array 200 may be any one of various shapes, including but not limited to a circular shape (e.g., FIG. 5) or an elongate or strip-like shape (e.g., in the form of a long strip as shown in FIG. 9). In some examples, the shape of each ultrasonic transducer 210 is configured to reduce or minimize the near field length (N) characterizing the ultrasonic transducer.

For example, considering that the near field length (N) of a square ultrasonic transducer is about 1.37 times that of a circular ultrasonic transducer with a diameter equal to the side length of the square ultrasonic transducer, the circular (or round) ultrasonic transducer or elongate (strip-like) ultrasonic transducer would be preferred to the square ultrasonic transducer in some embodiments. Nevertheless, this example does not preclude the use of square ultrasonic transducers in various applications.

In another example, strip-like ultrasonic transducers 210 may be selected. The near field length (N) of a strip-like ultrasonic transducer decreases with increasing length-to-width ratio. In some examples, the ultrasonic transducer array 200 includes a plurality of strip-like ultrasonic transducers 210, in which each of the strip-like ultrasonic transducer has a length-to-width ratio exceeding three (e.g., the length of the strip-like ultrasonic transducer 210 is at least three times longer than the width of the strip-like ultrasonic transducer 210). In the present context, an ultrasonic transducer 210 may be described as a long strip or a long stripe if the length-to-width ratio is greater than three.

Various shapes may be selected for the ultrasonic transducers 210. If the shape of the ultrasonic transducer 210 includes corners, the corners may be rounded, filleted, beveled, or chamfered. Each ultrasonic transducer 210 may be configured with a shape conducive to reduce the near field length.

Since the ultrasonic waves originate from numerous points along the transducer face, the ultrasonic waves would interfere and lead to extensive fluctuations in the sound intensity near the transducer face, also known as near field. The main difference for ultrasonic transducers with different shapes is the near field length. Because of acoustic variations and complications within the near field, the transducers are designed to reduce the near field length.

FIG. 2 is a schematic diagram showing a spread beam or a spread wave 300 generated by a single ultrasonic transducer 210, relative to the region 132 of interest or, more particularly, relative to the surface defect 130 to be monitored, in accordance with embodiments of the present disclosure. The spread wave 300 may be described as having a central line 302 (e.g., axis of symmetry). The spread wave 300 may be characterized by a “spread angle” indicative of the extent to which the ultrasonic wave has spread out from the ultrasonic transducer 210 generating the ultrasonic wave. Beam spreading or wave spreading may result from small-angle scattering, resulting in an increased beam divergence and reduced spatial power density at the receiver. A maximum distance Imax (between the surface defect 130 and the ultrasonic transducer 210) may be determined, in which the maximum is indicative of the detectable range of the ultrasonic transducer 210. To aid understanding, a direction or distance along the proximal wall 110 is referred to as “longitudinal” (e.g., along the x-axis shown in FIG. 2). The ultrasonic transducer is disposed on the proximal wall 110 and oriented with a sufficient angular displacement β between the central line 302 and the longitudinal direction x so as to transmit and/or receive an ultrasonic wave to/reflected from the distal wall 120. The ultrasonic transducer 210 and the surface defect 130 are longitudinally spaced apart by the maximum distance when the surface defect 130 is reachable only by the wave at an edge of the spread wave 300. The maximum distance may be determined according to Equation (1) and Equation (2), in which the ultrasonic transducers are assumed to be circular.

$$Sin \frac{θ}{2} = \frac{0.514 λ}{2 a} \qquad ( 1 )$$

$${I}_{max} = ( 2 t - d ) tan \frac{θ}{2} \approx \frac{0.514 t λ}{a} \qquad ( 2 )$$

in which θ is the beam divergence angle, α is the radius of the ultrasonic transducer, t is the thickness of the structure, λ is the wavelength, and lₘₐₓ is the maximum distance that the ultrasonic transducer can be spaced apart from the surface defect.

In examples where the ultrasonic transducer 210 is circular, the maximum distance (between the surface defect and a geometric center of the ultrasonic transducer) is 0.514 times the wavelength of the generated ultrasonic bulk wave multiplied by the thickness of the structure 100 and divided by the radius of the ultrasonic transducer.

In examples where the ultrasonic transducer 210 is strip-like, the maximum distance may be determined by Equation (3) and Equation (4):

$$sin \frac{θ}{2} = \frac{0.514 λ}{w} \qquad ( 3 )$$

$${I}_{max} = ( 2 t - d ) tan \frac{θ}{2} \approx \frac{t λ}{w} \qquad ( 4 )$$

in which w is the width of the strip-like ultrasonic transducer.

In examples where the ultrasonic transducer 210 is a long strip (e.g., strip-like with a length-to-width ratio that is greater than 3), the maximum distance (between the surface defect and a geometric center of the ultrasonic transducer) is one wavelength multiplied by the thickness of the structure 100 and divided by the width of the ultrasonic transducer.

### Example 1

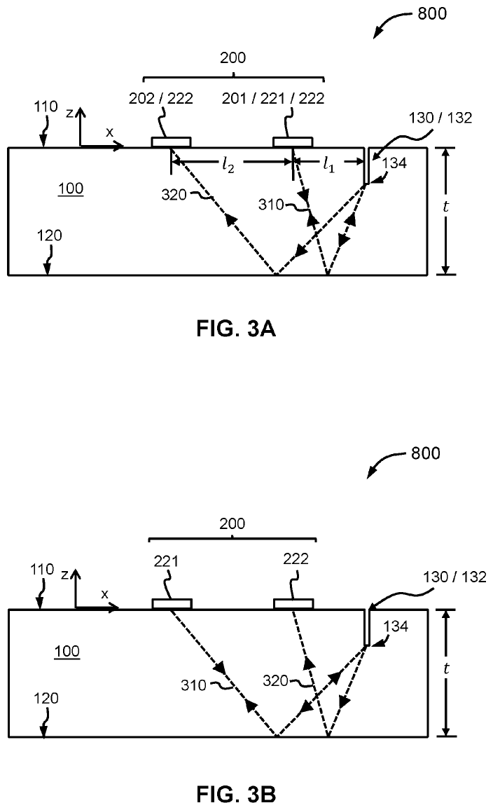

An example is described with reference to FIG. 3A to aid understanding and not to be limiting. FIG. 3A is a schematic illustrating one embodiment of the method 900 useful for simultaneously locating a surface defect 130 and determining the depth of the surface defect (also referred to as the “defect depth”). This may be particularly useful in situations where the defect depth and the defect-transducer distance between the surface defect 130 and the ultrasonic transducer 210 are unknown.

An ultrasonic transducer array 200 containing at least two ultrasonic transducers 210 is placed on the surface of interest 110 with both the ultrasonic transducers 210 positioned at the same side of the defect 130. In this embodiment, the ultrasonic transducer array 200 includes two ultrasonic transducers 210, in which one of the ultrasonic transducers serves as both the ultrasonic bulk wave transmitter 221 and ultrasonic bulk wave receiver 222, and the other ultrasonic transducer serves only as an ultrasonic bulk wave receiver 222.

As shown in FIG. 3A, ultrasonic waves 310 are generated by a first ultrasonic transducer 201 (serving as the transmitter 221) and the twice reflected ultrasonic bulk 320 waves are received by both the first ultrasonic transducer 201 (serving as one of the receivers 222) and the second ultrasonic transducer 202 (serving as another of the receivers 222).

As shown in FIG. 3B, the positions of the ultrasonic bulk wave transmitter 221 and receiver 222 may be interchanged as long as they are on the same side of the defect 130.

Denoting the arrival time of the twice reflected ultrasonic bulk wave 320 received by the first ultrasonic transducer 201 and the second ultrasonic transducer 202 as T₁ and T₂ respectively:

$${T}_{1} = \frac{2 \sqrt{{l}_{1}^{2} + {( 2 t - d )}^{2}}}{c} \qquad ( 5 )$$

$${T}_{2} = \frac{\sqrt{{l}_{1}^{2} + {( 2 t - d )}^{2}} + \sqrt{{( {l}_{1} + {l}_{2} )}^{2} + {( 2 t - d )}^{2}}}{c} \qquad ( 6 )$$

The distance between the surface defect and the first ultrasonic transducer (l₁) and the defect depth (d) may be solved from Equations (5) and (6) as follows:

$${l}_{1} = \frac{{c}^{2} {T}_{2} ( {T}_{2} - {T}_{1} )}{2 {l}_{2}} - \frac{{l}_{2}}{2} \qquad ( 7 )$$

$$d = 2 t - \frac{1}{2} \sqrt{{( {cT}_{1} )}^{2} - {( \frac{{c}^{2} {T}_{2} ( {T}_{2} - {T}_{1} )}{{l}_{2}} - {l}_{2} )}^{2}} \qquad ( 8 )$$

Experiments were conducted in which a pair of ultrasonic transducers 210 were bonded on an aluminum block (example of a structure 100) with a thickness of 45 mm (millimeters). A surface defect 130 was simulated by machining a slot to a depth of 5.4 mm on a 45 mm-thick aluminum block. The ultrasonic transducers 210 used were strip-like with rounded corners. Each of the ultrasonic transducers 210 had a length of 10 mm and a width of 2 mm. The ultrasonic transducers 210 used may be described as long strips as the length-to-width ratio exceeds 3. The distance between the surface defect 130 and the (geometric) center of any of the ultrasonic transducers 210 was initially unknown.

A pulse with a frequency of 2 MHz (megahertz) was used as an excitation signal and applied to one of the ultrasonic bulk wave transducers (e.g., the first ultrasonic transducer).

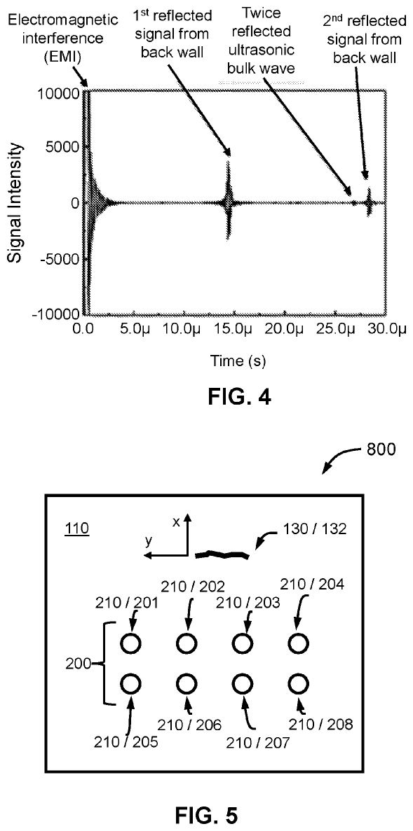

The ultrasonic wave signal obtained from one of the two ultrasonic transducers 210 is shown in FIG. 4. FIG. 4 shows electromagnetic interference at the first ultrasonic transducer (serving as the transmitter), a first reflected signal (reflected at the back wall 120) detected by the second ultrasonic transducer, and a first arrival time of the twice reflected ultrasonic bulk wave from the defect detected by the second ultrasonic transducer, and a second arrival time of a second reflected signal from the 120 detected by the second ultrasonic transducer.

The distance between the transmitter 221 and the receiver 222 was l₂=8 mm, and the distance between the center of the transmitter 221 and the surface defect 130 was l₁=7 mm. The twice reflected bulk wave 320 reached the transmitter 221 and the receiver 222 at 28.30 μs and 28.34 μs, respectively. Substituting T₁=28.30 μs, T₂=28.34 μs, and l₂=8 mm into Equations (6) and (7), the distance between the surface defect 130 and the transmitter 221 was determined to be l₁=7.27 mm and the depth of the surface defect was determined to be d=5.46 mm. The defect depth determined by the present method was only 1% larger than the actual defect depth.

### Example 2

FIG. 5 schematically illustrates a two dimensional (2D) ultrasonic transducer array 200 used for surface defect localization and depth monitoring in one experiment.

The structure 100 to be monitored may be of any various shapes, including but not limited to a flat shape, a tubular shape, or a shape with one or more bends. The number of ultrasonic transducers in the array may vary from example to example. Each ultrasonic transducer 210 may be configured to generate and detect ultrasonic bulk waves. In operation (e.g., during structure monitoring and/or evaluation), one of the ultrasonic transducers may be selected to serve as an ultrasonic bulk wave transmitter, and all the ultrasonic transducers in the array may be configured to serve as ultrasonic bulk wave receivers.

In the experiment, a surface defect was simulated by machining a slot with a length of 12 mm on a surface of the 38 mm-thick aluminum block.

Multiple sets of ultrasonic transducers may be bonded or in-situ fabricated on the surface of the structure 100 to be monitored. The ultrasonic transducer array 200 in this example was in-situ fabricated on the aluminum block on the same surface as the surface defect. The ultrasonic transducer array 200 included ultrasonic transducers in the form of circular elements. Each circular element has a diameter of 4 mm. The circular elements were disposed with the centers of adjacent circular elements a distance of 8 mm apart.

More particularly, in the experiment, four sets of ultrasonic transducers 210 were used to collectively form the 2D ultrasonic transducer array 200 of eight ultrasonic transducers 210. Each set includes at least two ultrasonic transducers 210 in which at least one ultrasonic transducer 210 in the set is configured as a transmitter 221 and receiver 222, and in which at least one other ultrasonic transducer 210 in the set is configured as a receiver 222. For example, at least four ultrasonic transducers 210 may be selected from the ultrasonic transducer array 200 to monitor the location and depth of a surface defect 130 over a relatively large area of the surface of interest (e.g., to monitor a larger area compared to Example 1).

In operation, an excitation pulse signal with a frequency of 2 MHz was applied to the ultrasonic transducer array 200. The location and depth of a surface defect 130 may be simultaneously monitored as described above.

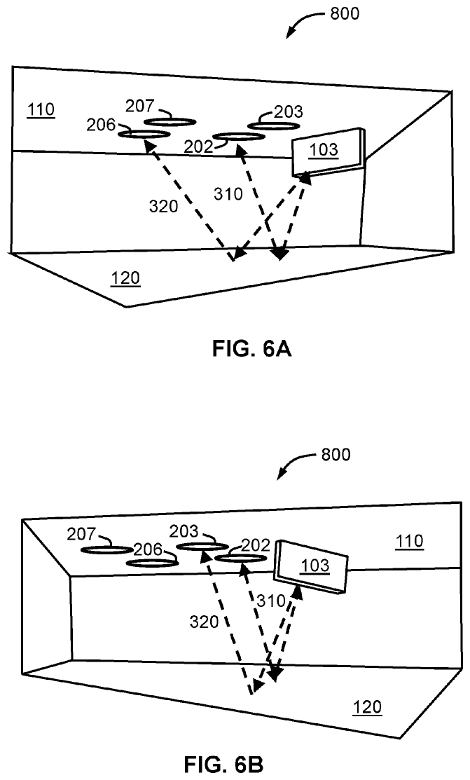

FIG. 6A and FIG. 6B are different perspective views of the schematic diagram of FIG. 5 to better illustrate the proposed method 900. In FIG. 6A, the array was configured based on a second ultrasonic transducer 202 selected to operate as an ultrasonic bulk wave transmitter 221 and a sixth ultrasonic transducer 206 selected to operate only as an ultrasonic bulk wave receiver 222. Different ones of the ultrasonic transducers 210 in the same array 200 may be selected for use. FIG. 6B is another perspective view of the schematic diagram of FIG. 5 in which the second ultrasonic transducer 202 is configured to operate as the ultrasonic bulk wave transmitter 221 and in which the third ultrasonic transducer 203 was configured to operate only as an ultrasonic bulk wave receiver 222.

The surface defect length may be calculated by analyzing the twice reflected ultrasonic bulk waves 320 from ultrasonic transducers 210 placed at different locations.

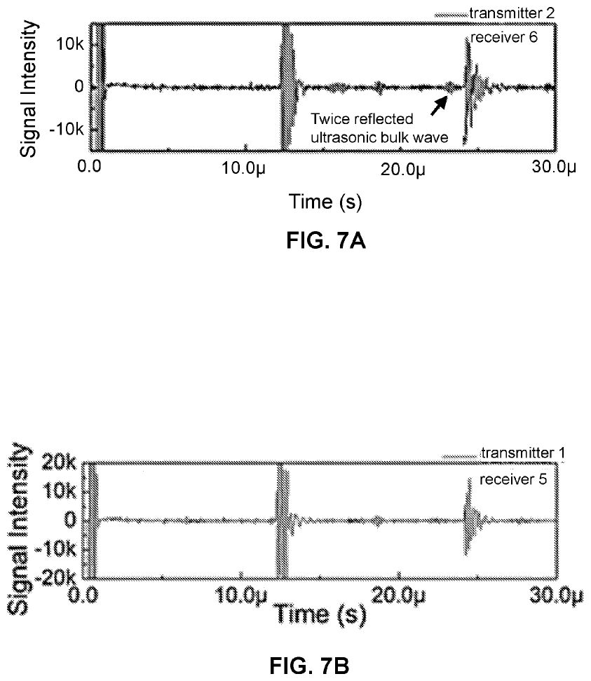

For example, FIG. 7A shows the ultrasonic wave signals detected when the second ultrasonic transducer 202 was the ultrasonic bulk wave transmitter and the sixth ultrasonic transducer 206 was the ultrasonic bulk wave receiver. FIG. 7B shows the ultrasonic wave signals when the first ultrasonic transducer 201 was the ultrasonic bulk wave transmitter 221 and a fifth ultrasonic transducer 205 was the ultrasonic bulk wave receiver 222.

When the second ultrasonic transducer 202 was taken as the ultrasonic bulk wave transmitter 221, and the sixth ultrasonic transducer 206 was taken as the ultrasonic bulk wave receiver 222, the twice reflected ultrasonic bulk wave could be clearly seen at 22.54 μs, indicating a defect 130 near the second ultrasonic transmitter 222.

When the first ultrasonic transducer 201 was used as the ultrasonic bulk wave transmitter 221, and the fifth ultrasonic transducer 205 was used as the ultrasonic bulk wave receiver 222, no twice reflected ultrasonic bulk wave could be observed, indicating that there was no surface defect near the first ultrasonic transducer.

When the same test was performed using the set of third ultrasonic transducer 203 and the seventh ultrasonic transducer 207, or using the set including the fourth ultrasonic transducer 204 and the eighth ultrasonic transducer 208, the surface defect 130 could be identified in the proximity of the second ultrasonic transducers as well as in the proximity of the third ultrasonic transmitter. Thus, the surface defect length could be estimated to be 12 mm.

The surface defect depth can be monitored by collecting the data at different defect depths.

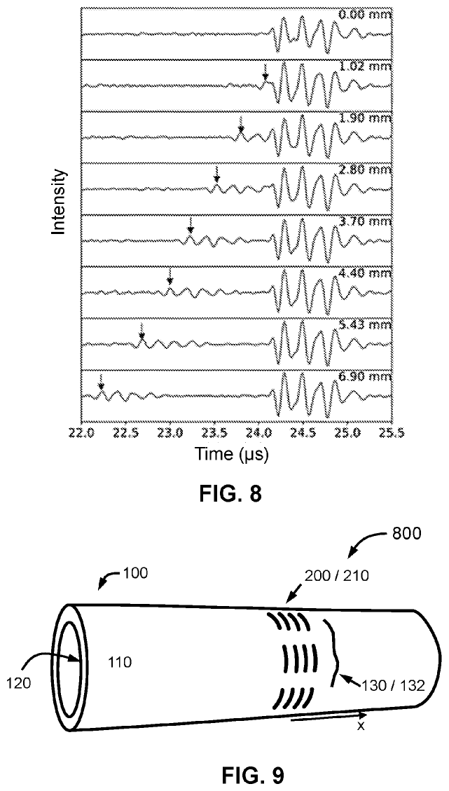

To demonstrate, multiple slots of incremental depths from 0 mm to 6.9 mm could be machined, or one slot may be progressively machined for an incrementally deeper defect depth to simulate defect propagation. When the second ultrasonic transducer 202 was used as the ultrasonic bulk wave transmitter 221, the ultrasonic signals received by the third ultrasonic transducer 203 are shown in FIG. 8. As the surface defect depth increases, the received twice reflected ultrasonic bulk wave arrives earlier, as marked in FIG. 8 by the arrows.

The difference in the ultrasonic wave signal arrival times can be used to monitor the surface defect depth growth. For example, the estimated distance from the center of the second ultrasonic transducer to the surface defect was 7.32 mm while the actual distance is 7 mm, and the corresponding surface defect depths were 0.95 mm, 1.79 mm, 2.95 mm, 3.52 mm, 4.68 mm, 5.49 mm, and 7.18 mm, which are less than 5% from the actual depth measured by a caliper, the results are shown in Table. 1.

TABLE 1
Comparison of defect depths measured

| | Defect depth as |
|---|---|
| Defect depth as | measured by the proposed |
| measured by calipers | method and system |
| (mm) | (mm) |
| 1.02 | 0.95 |
| 1.90 | 1.79 |
| 2.80 | 2.95 |
| 3.70 | 3.52 |
| 4.40 | 4.68 |
| 5.43 | 5.49 |
| 6.90 | 7.18 |

### Example 3

Example 3 illustrates an example of the present method 900 for monitoring the depth of a surface defect on a tubular structure 100.

An ultrasonic array 200 was bonded or in-situ fabricated on a curved shaped structure 100 (curved surface) to be monitored. The structure 100 to be monitored with a surface defect can be a flat, tubular, or bent structure.

In this example, the ultrasonic transducers 210 were “long strips” (e.g., strip-like ultrasonic transducers) with length-to-width ratios larger than 3 as well as rounded corners. Multiple sets of the ultrasonic transducers 210 were equally spaced apart and aligned in an array, with their long sides parallel (or substantially parallel) to the surface defect on the same surface (surface of interest 110). As shown in FIG. 9, the ultrasonic transducer arrays 200 may be bonded or in-situ fabricated around the circumference of a tubular structure 100 to detect, localize, and monitor the depth of the surface defect.

The ultrasonic transducer array 200 may be disposed such that the ultrasonic wave signal from the farthest ultrasonic transducer (relative to the surface defect) could reach the defect after being reflected by the back wall 120. The ultrasonic transducers in the ultrasonic transducer array 200 may be shaped such that the strip length exceeds 3 times the strip width.

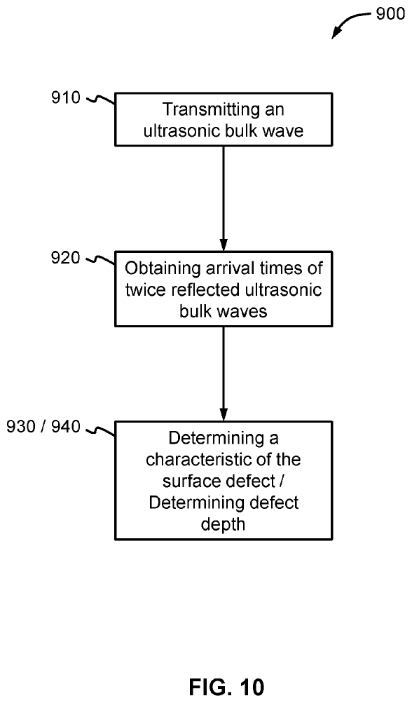

FIG. 10 provides a schematic diagram to illustrate embodiments of the present method 900. The method 900 may include a step (910) of transmitting an ultrasonic bulk wave from a proximal wall, and a step (920) of obtaining the respective arrival times of twice reflected ultrasonic bulk waves at two physically spaced apart locations on the proximal wall, the surface defect being on the proximal wall. The ultrasonic bulk wave is a spread wave and transmitted with the central line of the spread wave in a direction angularly displaced relative to the proximal wall. For the sake of brevity, the ultrasonic bulk wave may be described as being transmitted into the material of the structure, as opposed to being transmitted along a surface of the structure. The ultrasonic bulk wave may be transmitted toward a distal wall (back wall) that opposes or substantially opposes the proximal wall. The method may include a step (930) of determining characteristics of the surface defect based on the respective arrival times. The characteristics of the surface defect may include a distance from the surface defect to any one or more of the ultrasonic transducers in the set. The characteristics of the surface defect may include a step (940) of determining a depth of the surface defect.

In the foregoing, various embodiments of a method 900 have been described. The method 900 is useful for determining the location and depth of a surface defect 130 in a structure 100. The method 900 may involve analyzing the arrival time of a twice reflected ultrasonic bulk wave 320, in which the ultrasonic bulk wave 320 is a spread wave 300 excited and detected by an ultrasonic transducer array 200.

In some embodiments, the method 900 as described is characterized in that the twice reflected ultrasonic bulk wave 320 is the ultrasonic bulk wave propagated along the following path: the ultrasonic bulk wave is generated by an ultrasonic transducer 210 in the ultrasonic transducer array 200, reaches the back wall 120 of the structure 100, reflected from back wall 120 of the structure 100, reaches the surface defect tip, diffracted at the surface defect tip, reaches the back wall 120 of the structure 100 again, reflected from back wall 120 of the structure 100, and detected by the ultrasonic transducers in the ultrasonic transducer array 200. The method 900 for determining the location and depth of a surface defect in a structure 100 is by analyzing the arrival time of a twice reflected ultrasonic bulk wave 320, wherein the ultrasonic bulk wave is a spread wave 300 excited and detected by an ultrasonic transducer array 200. The spread wave 300 is directed into the material of the structure, with a central line 302 of the spread wave 300 being angularly displaced (β) relative to the proximal wall 110. In some examples, the angular displacement β is 90 degrees or about 90 degrees. In some examples, the angular displacement β is determined by the thickness of the structure (e.g., the distance between the proximal surface 110 and the back wall 120). In some examples, the angular displacement β is at least large enough to enable the formation of a twice reflected ultrasonic wave 320.

The ultrasonic transducer array 200 may contain at least two ultrasonic transducers 210 fabricated on the same side of the defect 130. The ultrasonic transducers 210 may be equally spaced apart and aligned in an array 200, e.g., the ultrasonic transducers 210 may be evenly spaced apart from one another to form a two-dimensional array 200 characterized by a regular pattern. The ultrasonic transducer 210 may be in a circle or a long strip shape. The ultrasonic transducers 210 may be circular, and the distance between the surface defect and the center of any ultrasonic transducer is at most 0.514 times the wavelength of the generated ultrasonic bulk wave multiplied by the thickness of the structure 100 and divided by the radius of the circular ultrasonic transducer. The ultrasonic transducers 210 may be long strips, and their length (strip length) exceeds 3 times their width (strip width). The ultrasonic transducers 210 of long strips have rounded corners. The ultrasonic transducers 210 of long strips, the long sides are parallel to the surface defect on the same surface. The ultrasonic transducers 210 are long strips, the distance between the surface defect and the center of any ultrasonic transducer 210 is at most one wavelength multiplied by the thickness of the structure 100 and divided by the width of the long strip ultrasonic transducer.

The method 900 as described in which multiple sets of ultrasonic transducer array 200 are bonded or in-situ fabricated on the surface 110 of the structure 100 to be monitored, forming a 2D ultrasonic transducer array 200. The methods as described in which the ultrasonic transducers 210 are fabricated on the structure 100 with an in-situ fabrication technique, include but are not limited to spray coating, spin coating, thermal spray, and tape casting.

The method 900 as described in which the materials for the ultrasonic transducer array 200 include but are not limited to piezoelectric ceramic and piezoelectric polymer. The ultrasonic transducer array 200 may include (but is not limited to) one or more of the following: a piezoelectric ceramic transducer and a piezoelectric polymer transducer.

The method 900 may be applied to monitor a surface defect 130 in a structure 100 that may be a flat, tubular, or bent structure.

The present method 900 and system 800 for monitoring the depth of a surface defect 130 on a structure 100 is based on detecting twice reflected ultrasonic bulk waves 320, generated and detected using ultrasonic bulk wave transmitter 221 and ultrasonic bulk wave receiver 222 array 200. Advantageously, the transducers 210 may be bonded or in-situ fabricated on the same side of the surface defect 130 with no wedge and/or couplant required.

Ultrasonic testing is widely used due to its high sensitivity, high accuracy, fast response, both long distance surface propagation and deep penetration depending on the ultrasonic wave modality. However, the Rayleigh wave method is only sensitive to crack depths of the same order of magnitude as the penetration depth of the incident Rayleigh surface wave. On the contrary, ultrasonic bulk waves can be utilized to monitor deeper surface cracks as ultrasonic bulk waves propagate in thickness direction of the structure. When an ultrasonic bulk wave reaches a crack, the tip of the crack will diffract the ultrasonic bulk wave, creating a spherical wavefront that can be used to locate the tip and measure the depth of the crack. In the prior art, in the surface crack monitoring methods based on ultrasonic bulk wave, Phased Array (PA) is typically used to collect data in the area of interest where the PA has been installed. However, PA method can only detect specific highly localized region depending on the steering direction of the ultrasonic bulk wave beam.

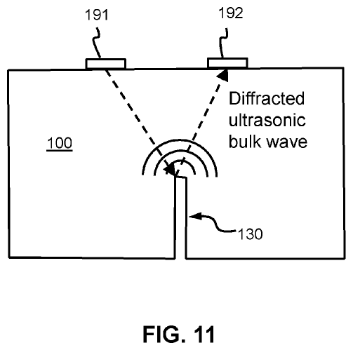

In conventional ultrasonic inspection, the transmitter 191 and the receiver 192 are typically placed at different sides of the surface crack 130 (as illustrated in FIG. 11) so as to minimize the distance between the transducers and the surface crack and take advantage of the stronger wave energy. It can be appreciated that the ultrasonic waves would be reflected only once or not at all before they are detected.

In conventional ultrasonic inspection, the transducers are typically mounted on a wedge so as to direct the ultrasonic waves at an angle conducive for reflection at the surface crack. It would be further appreciated that when a phased array or transducer on a wedge to generate and detect the ultrasonic signal, the spread angle is limited, and a shallow crack near the surface could not be detected.

In one aspect, according to various embodiments of the present disclosure, a method of monitoring a surface defect on a proximal wall of a structure 100 includes transmitting a generated ultrasonic bulk wave from an ultrasonic transducer array disposed on the proximal wall, the generated ultrasonic bulk wave being transmitted from the proximal wall as a spread wave having a central line angularly displaced relative to the proximal wall. The method includes determining at least one characteristic of the surface defect based on reflected ultrasonic bulk wave sensed by the ultrasonic transducer array, the ultrasonic transducer array being disposed on the proximal wall and disposed to one side of the surface defect.

The method may include determining at least one characteristic of the surface defect based on respective arrival times of the reflected ultrasonic bulk wave sensed by at least two ultrasonic transducers selected from the ultrasonic transducer array.

The method may include determining a depth of the surface defect based on the respective arrival times of the reflected ultrasonic bulk wave.

The method may include determining a distance between the surface defect and the ultrasonic transducers based on the respective arrival times of the reflected ultrasonic bulk wave.

The method may include simultaneously determining a depth of the surface defect and determining a distance between the surface defect and a first selected ultrasonic transducer based on respective arrival times of the reflected ultrasonic bulk wave sensed by at least two ultrasonic transducers selected from the ultrasonic transducer array.

The reflected ultrasonic bulk wave may include a twice reflected ultrasonic bulk wave.

The reflected ultrasonic bulk wave comprises an ultrasonic bulk wave that has been twice reflected at a distal wall of the structure, in which the distal wall opposes the proximal wall.

The twice reflected ultrasonic bulk wave may include an ultrasonic bulk wave that has been diffracted at the surface defect.

The generated ultrasonic bulk wave may be propagated along a path including in sequential order: (i) a transmission from the proximal wall; (ii) a first reflection at a distal wall of the structure 100, the distal wall opposing the proximal wall; (iii) a diffraction at the surface defect tip; and (iv) a second reflection at the distal wall to form a twice reflected ultrasonic wave receivable at the ultrasonic transducer array at the respective arrival times.

The method may include: configuring a first ultrasonic transducer as a transmitter of the ultrasonic bulk wave and configuring the first ultrasonic transducer as a first receiver of a reflected ultrasonic bulk wave; configuring a second ultrasonic transducer as a second receiver of the reflected ultrasonic bulk wave, in which the first ultrasonic transducer and the second ultrasonic transducer are selected from different ones of a plurality of ultrasonic transducers of the ultrasonic transducer array, and in which the plurality of ultrasonic transducers is distributed physically apart from one another over an area of the proximal surface to form a two-dimensional array.

The method may further include disposing the array of ultrasonic transducers longitudinally spaced apart from the surface defect with the at least two ultrasonic transducers being disposed on a same side of the surface defect.

The ultrasonic transducer array may include a plurality of ultrasonic transducers aligned and evenly spaced apart from one another to form a two-dimensional array characterized by a regular pattern.

Each of the at least two transducers may be configured as a strip characterized by a strip length and a strip width, the strip length being longer than the strip width, in which each of the at least two ultrasonic transducers is disposed with the respective strip length being parallel to one another. The strip may include a plurality of rounded corners. A respective center of the at least two ultrasonic transducer may be longitudinally spaced apart from the surface defect by a distance l≤λt/w wherein λ is one wavelength of the generated ultrasonic bulk wave, t is a thickness of the structure 100, and w is the strip width.

Alternatively, each of the at least two transducers may be configured in a circular shape characterized by a radius, in which a respective center of the at least two ultrasonic transducer is longitudinally spaced apart from the surface defect by a distance l≤λt/r, wherein λ is one wavelength of the generated ultrasonic bulk wave, t is a thickness of the structure 100, and r is the radius.

The method according to any described above in which the surface defect includes a surface crack.

In another aspect, according to various embodiments of the present disclosure, a device for monitoring a surface defect on a proximal wall of a structure includes an ultrasonic transducer array and a processor. The ultrasonic transducer array includes a plurality of ultrasonic transducers spaced apart from one another, the ultrasonic transducer array being disposed on the proximal wall and oriented to transmit a generated ultrasonic bulk wave spread from the proximal wall with the central line of the spread wave in a direction normal or substantially normal to the proximal wall. The processor is operably coupled to the ultrasonic transducer array, the processor being configured to determine at least one characteristic of the surface defect based on a twice reflected ultrasonic bulk wave sensed by at least two selected from the plurality of ultrasonic transducers, in which the ultrasonic transducer array is longitudinally spaced apart from the surface defect.

The reflected ultrasonic bulk wave sensed may include a twice reflected ultrasonic bulk wave.

The processor may be configured to determine the at least one characteristic of the surface defect based on respective arrival times of the reflected ultrasonic bulk wave. The at least one characteristic may include any one or more of the following: a depth of the surface defect, a distance between the surface defect and a first selected ultrasonic transducer, and a presence of the surface defect.

The processor may be configured to simultaneously determine a depth of the surface defect and determine a distance between the surface defect and a first selected ultrasonic transducer based on the respective arrival times of the reflected ultrasonic bulk wave sensed by at least two ultrasonic transducers selected from the ultrasonic transducer array.

The device configured to generate and/or receive the reflected ultrasonic bulk wave that includes a twice reflected ultrasonic bulk wave reflected at a distal wall of the structure 100, in which the distal wall opposes the proximal wall. The reflected ultrasonic bulk wave may include a diffracted ultrasonic bulk wave at the surface defect tip.

The ultrasonic transducer array may be characterized by a detectable range to detect a twice reflected ultrasonic wave, in which the twice reflected ultrasonic wave is characterized by a propagation path comprising in sequential order: (i) a transmission from the proximal wall; (ii) a first reflection at a distal wall of the structure 100, the distal wall opposing the proximal wall; (iii) a diffraction at the surface defect tip; and (iv) a second reflection at the distal wall to form the twice reflected ultrasonic wave receivable at the ultrasonic transducer array at the respective arrival times.

The device in which each of the plurality of ultrasonic transducers is characterized by a circular shape.

The device in which each of the plurality of ultrasonic transducers is characterized by a strip-like shape.

The device in which each of the plurality of ultrasonic transducers is characterized by a length-to-width ratio greater than 3.

The device in which each of the plurality of the ultrasonic transducers has rounded corners.

The device in which the plurality of ultrasonic transducers are in-situ fabricated on the structure.

The device in which the ultrasonic transducer array includes one or more of the following: a piezoelectric ceramic transducer and a piezoelectric polymer transducer.

The device in which the structure 100 is characterized by any one of the following shapes: flat, tubular, bent, and any combination thereof.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the claimed invention.

1. A method of monitoring a surface defect on a proximal wall of a structure, comprising:
transmitting a generated ultrasonic bulk wave from an ultrasonic transducer array disposed on the proximal wall, the generated ultrasonic bulk wave being transmitted from the proximal wall as a spread wave having a central line angularly displaced relative to the proximal wall; and
determining at least one characteristic of the surface defect based on a reflected ultrasonic bulk wave sensed by the ultrasonic transducer array, the ultrasonic transducer array being disposed on the proximal wall and disposed to one side of the surface defect.

2. The method as recited in claim 1, comprising:
determining at least one characteristic of the surface defect based on respective arrival times of the reflected ultrasonic bulk wave sensed by at least two ultrasonic transducers selected from the ultrasonic transducer array.

3. The method as recited in claim 2, comprising:
determining a depth of the surface defect based on the respective arrival times of the reflected ultrasonic bulk wave.

4. The method as recited in claim 2, comprising:
determining a distance between the surface defect and the ultrasonic transducers based on the respective arrival times of the reflected ultrasonic bulk wave.

5. The method as recited in claim 1, comprising:
simultaneously determining a depth of the surface defect and determining a distance between the surface defect and a first selected ultrasonic transducer based on respective arrival times of the reflected ultrasonic bulk wave sensed by at least two ultrasonic transducers selected from the ultrasonic transducer array.

6. (canceled)

7. The method as recited in claim 1, wherein the reflected ultrasonic bulk wave is twice reflected at a distal wall of the structure, wherein the distal wall opposes the proximal wall.

8. (canceled)

9. The method as recited in claim 1, wherein the generated ultrasonic bulk wave is propagated along a path comprising in sequential order:
a transmission from the proximal wall;
a first reflection at a distal wall of the structure, the distal wall opposing the proximal wall;
a diffraction at the surface defect tip; and
a second reflection at the distal wall to form a twice reflected ultrasonic wave receivable at the ultrasonic transducer array at the respective arrival times.

10. (canceled)

11. The method as recited in claim 2, further comprising disposing the array of ultrasonic transducers longitudinally spaced apart from the surface defect with the at least two ultrasonic transducers being disposed on a same side of the surface defect.

12. The method as recited in claim 11, wherein the ultrasonic transducer array comprises a plurality of ultrasonic transducers aligned and evenly spaced apart from one another to form a two-dimensional array characterized by a regular pattern.

13. The method as recited in claim 11, wherein each of the at least two transducers is configured as a strip characterized by a strip length and a strip width, the strip length being longer than the strip width, and wherein each of the at least two ultrasonic transducers is disposed with the respective strip length being parallel to one another.

14. (canceled)

15. (canceled)

16. (canceled)

17. (canceled)

18. A device for monitoring a surface defect on a proximal wall of a structure, comprising:
an ultrasonic transducer array, the ultrasonic transducer array including a plurality of ultrasonic transducers spaced apart from one another, the ultrasonic transducer array being disposed on the proximal wall and oriented to transmit a generated ultrasonic bulk wave from the proximal wall as a spread wave having a central line angularly displaced relative to the proximal wall; and
a processor, the processor being operably coupled to the ultrasonic transducer array, the processor being configured to determine at least one characteristic of the surface defect based on a twice reflected ultrasonic bulk wave sensed by at least two selected from the plurality of ultrasonic transducers, wherein the ultrasonic transducer array is longitudinally spaced apart from the surface defect.

19. (canceled)

20. The device as recited in claim 18, wherein the processor is configured to determine the at least one characteristic of the surface defect based on respective arrival times of the reflected ultrasonic bulk wave.

21. The device as recited in claim 20, wherein the at least one characteristic comprises any one or more of the following: a depth of the surface defect, a distance between the surface defect and a first selected ultrasonic transducer, and a presence of the surface defect.

22. The device as recited in claim 21, wherein the processor is configured to simultaneously determine a depth of the surface defect and determine a distance between the surface defect and a first selected ultrasonic transducer based on the respective arrival times of the reflected ultrasonic bulk wave sensed by at least two ultrasonic transducers selected from the ultrasonic transducer array.

23. The device as recited in claim 20, wherein the twice reflected ultrasonic bulk wave comprises a twice reflected ultrasonic bulk wave reflected at a distal wall of the structure, and wherein the distal wall opposes the proximal wall.

24. The device as recited in claim 23, wherein the reflected ultrasonic bulk wave comprises a diffracted ultrasonic bulk wave at the surface defect tip.

25. The device as recited in claim 18, wherein the ultrasonic transducer array is characterized by a detectable range to detect a twice reflected ultrasonic wave, and wherein the twice reflected ultrasonic wave is characterized by a propagation path comprising in sequential order:
a transmission from the proximal wall;
a first reflection at a distal wall of the structure, the distal wall opposing the proximal wall;
a diffraction at the surface defect tip; and
a second reflection at the distal wall to form the twice reflected ultrasonic wave receivable at the ultrasonic transducer array at the respective arrival times.

26. The device as recited in claim 25, wherein each of the plurality of ultrasonic transducers is characterized by one of the following: a circular shape and a strip-like shape.

27. (canceled)

28. The device as recited in claim 26, wherein each of the plurality of ultrasonic transducers is characterized by a length-to-width ratio greater than 3.

29. (canceled)

30. The device as recited in claim 18, wherein the plurality of ultrasonic transducers are in-situ fabricated on the structure.

31. (canceled)

32. (canceled)
